(19) United States
(12) Patent Application Publication
(10) Pub. No.: US 2006/0040773 A1
(43) Pub. Date: Feb. 23, 2006

(54) Power transfer system with continuously variable torque transfer mechanism

(76) Inventor: Richard Mizon, Fayetteville, NY (US)

Correspondence Address: HARNESS, DICKEY & PIERCE, P.L.C., P.O. BOX 828, BLOOMFIELD HILLS, MI, 48303, US

(21) Appl. No.: 10/922,285

(22) Filed: Aug. 19, 2004

(51) Int. Cl. F16H 61/00; F16H 63/00; F16H 7/12

(52) U.S. Cl. 474/18; 474/8; 474/46

(57) ABSTRACT

A power transfer system includes an input shaft that is rotatably driven by a power source, a first output shaft that is coupled to the input shaft and that drives a first driveline and a second output shaft that drives a second driveline. A torque transfer mechanism selectively couples the first output shaft and the second output shaft. The torque transfer mechanism includes a first pulley selectively coupled to the first output shaft, a second pulley coupled to the second output shaft and a drive linkage that transfers drive torque between the first pulley and the second pulley. A first operating radius of the first pulley is varied to vary torque transfer between the first output shaft and the second output shaft.

### FIELD OF THE INVENTION

The present invention relates generally to power transfer systems, and more particularly to a variable torque transfer mechanism for controlling the distribution of drive torque between the front and rear drivelines of a four-wheel drive vehicle.

### BACKGROUND OF THE INVENTION

In view of increased demand for four-wheel drive vehicles, a plethora of power transfer systems are currently being incorporated into vehicular driveline applications for transferring drive torque to the wheels. In many vehicles, the power transfer system includes a transfer device (i.e., transfer case, PTU, coupling and the like) that is operably installed between the primary and secondary drivelines. Such transfer devices are typically equipped with a torque transfer mechanism for selectively and/or automatically transferring drive torque from the primary driveline to the secondary driveline to establish a four-wheel drive mode of operation. For example, the torque transfer mechanism can include a chain drive having a first sprocket that selectively rotates with a first output shaft and a second sprocket that is fixed for rotation with a second output shaft. A chain or other coupling connects the first and second sprockets.

The amount of torque transfer from the first output shaft to the second output shaft can be regulated based on traction control strategies. Traditionally, a clutch-pack has been implemented to regulate such torque transfer. Clutch-packs, however, generate significant heat that can result in damage to clutch-pack components or other components of the power transfer system. Therefore, torque transfer mechanisms that implement clutch-packs to enable torque transfer also require a cooling system to regulate heat generated by the clutch-pack. This results in a more complex and costly power transfer system.

### SUMMARY OF THE INVENTION

Accordingly, the present invention provides a power transfer system. The power transfer system includes a transfer device having an input shaft that is rotatably driven by a power source, a first output shaft that is coupled to the input shaft and that drives a first driveline and a second output shaft that drives a second driveline. In addition, a torque transfer mechanism is arranged to selectively couple the first output shaft and the second output shaft. The torque transfer mechanism includes a first pulley selectively coupled to the first output shaft, a second pulley coupled to the second output shaft and a drive linkage that transfers drive torque between the first pulley and the second pulley. A first operating radius of the first pulley is varied to vary torque transfer between the first output shaft and the second output shaft.

In other features, the power transfer system further includes a power-operated actuator that is operable to adjust the first operating radius. The actuator may be a ball-ramp type actuator. Alternatively, the actuator may be a ball-screw type actuator.

In another feature, the first pulley includes first and second pulley halves that are rotatably driven by the first output shaft. The second pulley half is movable along a linear axis relative to the first pulley half to vary the first operating radius.

In still other features, a second operating radius of the second pulley can be adjusted based on the first operating radius. In particular, the second operating radius can be adjusted to maintain a desired tension in the drive linkage. The second pulley includes first and second pulley halves that rotatably drive the second output shaft. The second pulley half is biased along a linear axis toward the first pulley half by a biasing member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further objects, features and advantages of the present invention will become apparent to those skilled in the art from analysis of the following written description, the appended claims, and accompanying drawings in which:

FIG. 1 illustrates an exemplary drivetrain of a four-wheel drive vehicle equipped with a power transfer system according to the present invention;

FIG. 2 is a cross-sectional view of a transfer case associated within the power transfer system and which includes a torque transfer mechanism according to the present invention;

FIG. 3 is schematic illustration of an alternative torque transfer mechanism according to the present invention;

FIG. 4 is a schematic illustration of another alternative torque transfer mechanism according to the present invention;

FIG. 5 is a schematic illustration of relative operating diameters of pulleys of the torque transfer mechanism in a first configuration;

FIG. 6 is a schematic illustration of the relative operating diameters of the pulleys in a second configuration; and

FIG. 7 is a schematic illustration of the relative operating diameters of the pulleys in a third configuration.

### DETAILED DESCRIPTION OF THE PREFERRED EMBODIMENTS

The present invention is directed to a torque transfer mechanism that can be adaptively controlled for modulating the torque transferred from a first rotary member to a second rotary member. The torque transfer mechanism finds particular application in power transfer systems for use in motor vehicle drivelines. Thus, while the present invention is hereinafter described in association with particular arrangements for use in specific driveline applications, it will be understood that the arrangements shown and described are merely intended to illustrate embodiments of the present invention.

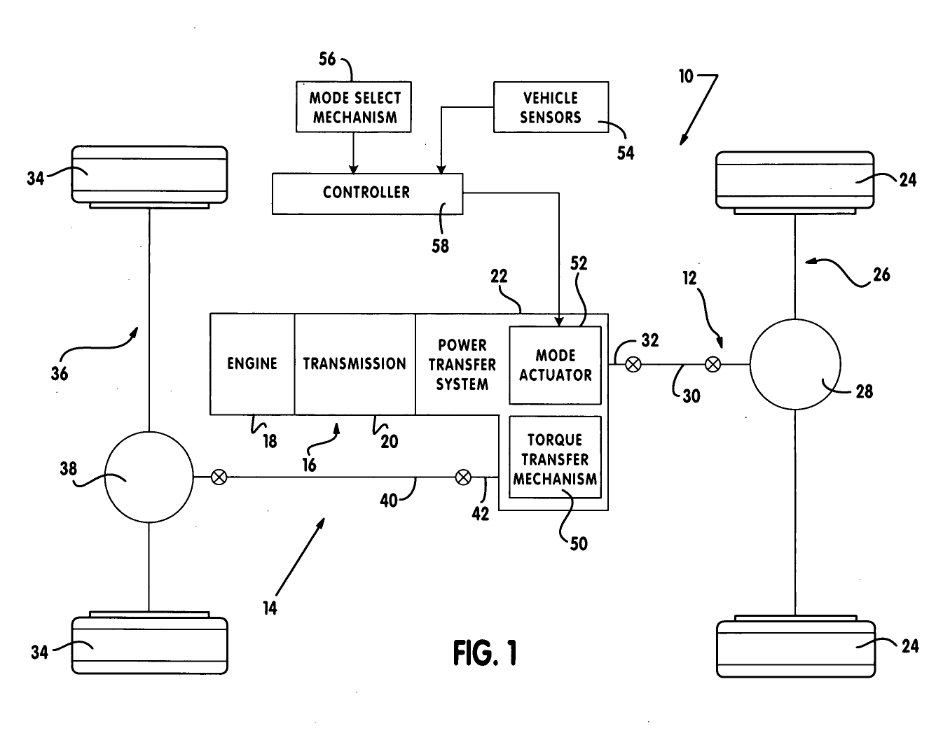

With particular reference to FIG. 1, a drivetrain 10 of a four-wheel drive vehicle is shown. The drivetrain 10 includes a primary driveline 12, a secondary driveline 14, and a powertrain 16 for delivering rotary tractive power (i.e., drive torque) to the drivelines 12,14. The powertrain 16 includes an engine 18 and a multi-speed transmission 20. In the particular arrangement shown, the primary driveline 12 is the rear driveline and the secondary driveline 14 is the front driveline. The drivetrain 10 further includes a power transfer system that is arranged to control the transfer of drive torque from powertrain 16 to one or both of drivelines 12, 14 and is shown to include a transfer case 22. The rear driveline 12 includes a pair of rear wheels 24 connected at opposite ends of a rear axle assembly 26 having a rear differential 28. The rear differential 28 is coupled to one end of a rear prop shaft 30, the opposite end of which is coupled to a rear output shaft 32 of transfer case 22. The front driveline 14 includes a pair of front wheels 34 connected at opposite ends of a front axle assembly 36 having a front differential 38. The front differential 38 is coupled to one end of a front prop shaft 40, the opposite, end of which is coupled to a front output shaft 42 of transfer case 22.

The transfer case 22 further includes a torque transfer mechanism 50 that varies torque transferred between the rear output shaft 32 and the front output shaft 42 and a power-operated actuator 52 for actuating the torque transfer mechanism 50. The power transfer system further includes vehicle sensors 54 for detecting certain dynamic and operational characteristics of the motor vehicle, a mode select mechanism 56 that enables the vehicle operator to select one of the available drive modes, and a controller 58 for controlling actuation of actuator 52 in response to input signals from vehicle sensors 54 and mode selector 56.

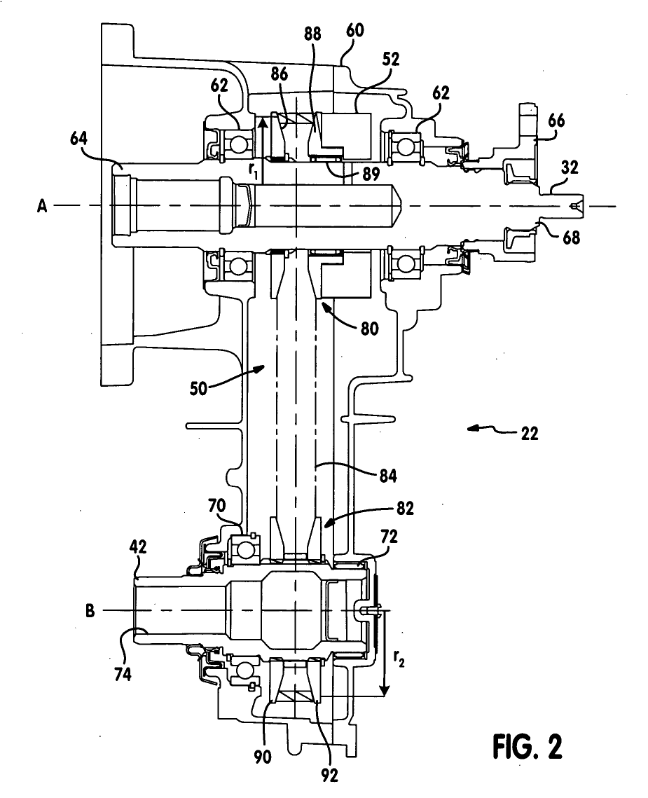

Referring now to FIG. 2, the transfer case 22 includes a multi-piece housing 60 from which there output shaft 32 is rotatably supported by a pair of laterally-spaced bearing assemblies 62. The rear output shaft 32 includes an internally-splined first end segment 64 adapted for connection to the output shaft of the transmission 20 and a yoke assembly 66 secured to its second end segment 68 that is adapted for connection to the rear propshaft 30. The front output shaft 42 is likewise rotatably supported within the housing 60 by a pair of laterally-spaced bearing assemblies 70 and 72 and includes an internally-splined end segment 74 that is adapted for connection to the front propshaft 40.

The torque transfer mechanism 50 includes an adjustable first pulley unit 80, a second pulley unit 82 and a traction belt 84. The adjustable first pulley unit 80 is fixed for rotation with the rear output shaft 32. The second pulley unit 82 is fixed for rotation with the front output shaft 42 and is driven by the adjustable pulley unit 80 via the belt 84. As explained further below, the adjustable pulley unit 80 can be adjusted to vary the amount of drive torque transferred to the second pulley unit 82. More specifically, the adjustable pulley unit 80 includes first and second pulley halves 86 and 88. The first pulley half 86 is fixed (i.e. splined) for rotation with the rear output shaft 32 and is fixed against axial movement along a linear axis “A” of the rear output shaft 32. In contrast, the second pulley half 88 is not fixed for rotation with the rear output shaft 32 and is axially slidable along the linear axis A. A bearing 89 rotably supports second pulley half 88 on rear output shaft 32. The linear position of the second pulley half 88 is adjusted by the actuator 52. While specific examples will be detailed hereinafter, actuator 52 can be any power-operated device capable of precisely controlling sliding movement of send pulley half 88 relative to first pulley half 86.

The belt 84 includes a tapered cross-section and engages conical faces of the first and second pulley halves 86,88. The belt 84 is driven about a first operating radius (r₁) of the adjustable pulley unit 80. More specifically, the first operating radius is defined by the depth at which the belt 84 rides between the first and second pulley halves 86,88. The first operating radius is adjustable by adjusting the linear position of the second pulley half 88 relative to the first pulley half 86. More specifically, as the second pulley half 88 moves away from the first pulley half 86, the belt 84 rides deeper and the operating radius is reduced. As the second pulley half 88 moves toward the first pulley half 86, the belt 84 rides higher and the operating radius is increased.

The second pulley unit 82 includes first and second pulley halves 90 and 92, both of which are linearly and rotatably fixed to the front output shaft 42. The first and second pulley halves 90,92 include conical faces, within which the belt 84 rides. Because the first and second pulley halves 90,92 are fixed relative to one another along a second linear axis B, the second operating radius (r₂) remains static. Adjustment of the first operating radius (r₁) without a corresponding adjustment in the second operating radius (r₂) results in a change in tension in the belt 84. For example, the tension is less in the belt 84 for a small operating radius than the tension for a large operating radius. To maintain a constant tension in the belt 84, a tensioner (not shown) can be included.

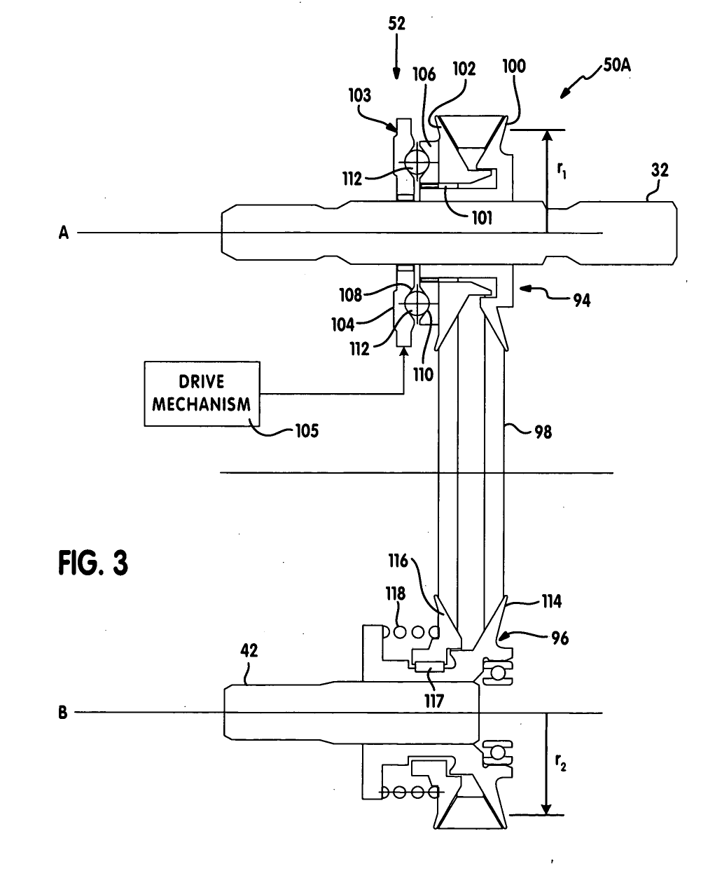

Referring now to FIG. 3, an alternative torque transfer mechanism 50A is illustrated. The alternative torque transfer mechanism 50A includes a first adjustable pulley unit 94, a second adjustable pulley unit 96 and a belt 98. The first adjustable pulley unit 96 is fixed for rotation with the rear output shaft 32 and is rotatably driven by the rear output shaft 32. The second adjustable pulley unit 96 is fixed for rotation with the front output shaft 42 and is driven by the first adjustable pulley unit 94 via the belt 98. As explained further below, the first adjustable pulley unit 94 is adjusted to vary the amount of torque transferred to the second adjustable pulley unit 96. More specifically, the first adjustable pulley unit 94 includes first and second pulley halves 100,102. The first pulley half 100 is fixed for rotation with the rear output shaft 32 and is fixed against axial movement along a linear axis A of the rear output shaft 32. The second pulley half 102 is supported by a bearing 101 for rotation relative to the rear output shaft 32 and is axially slidable along the linear axis A. The linear position of the second pulley half 102 is adjusted by the actuator 52.

In FIG. 3, the actuator 52 is shown to include a ball-ramp type operator 103 and a power-generated drive mechanism 105. Ball-ramp operator 103 includes first and second actuator plates 104,106 having first and second ramped grooves 108,110 respectively formed therein. Balls 112 ride within the first and second ramped grooves as discussed in further detail below. The first actuator plate 104 is rotatably supported about the rear output shaft 32 and the second actuator plate 106 abuts the second pulley half 102 and is slidable along the axis A to induce linear movement of the second pulley half 102. The second pulley half 102 rotates freely relative to the second actuator plate 106.

The first actuator plate 104 is rotated relative to the second actuator plate 106 by the drive mechanism 105, which can be electrically or hydraulically actuated, to drive the balls 112 within the first and second ramped grooves 108,110. When the balls 112 ride up the ramped grooves 108,110, the second actuator plate 106 is pushed away from the first actuator plate 104, moving it along the linear axis A to impart a linear force on the second pulley half 102. In this manner, the second pulley half 102 moves towards the first pulley half 100 and the operating radius (r₁) is increased. In contrast, when the balls 112 ride down the ramped grooves 108,110, the second actuator plate 106 moves toward the first actuator plate 104, relieving the linear force on the second pulley half 102. The tension on the belt 98 pushes the second pulley half 102 away from the first pulley half 100 and the operating radius (r₁) is decreased.

The second adjustable pulley unit 96 includes first and second pulley halves 114,116. The first pulley half 114 is rotatably and linearly fixed relative to the front output shaft 42. The second pulley half 116 is supported for rotation by bearing 117 on the first pulley half 114 and is slidable along the axis B. A spring 118 biases the second pulley half 116 toward the first pulley half 114. The spring rate of the spring 118 is selected to maintain a constant tension in the belt 98. More particularly, the tension in the belt 98 results in a linear force being imparted on the second pulley half 116. As the tension increases, the linear force increases and the second pulley half 116 compresses the spring 118 until an equilibrium is achieved. As the tension decreases, the linear force decreases and the second pulley half 116 is biased towards the first pulley half 114 by the spring 118 until an equilibrium is achieved. In this manner, the second operating radius (r₂) is automatically adjusted when the first operating radius (r₁) is adjusted to maintain a constant belt tension.

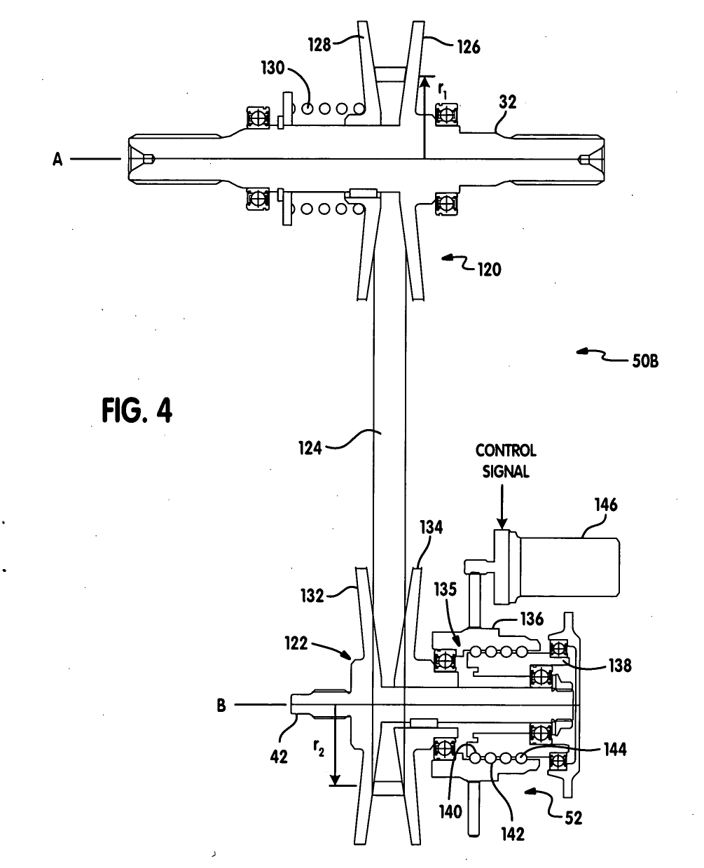

Referring now to FIG. 4, another alternative torque transfer mechanism 50B is illustrated. The alternative torque transfer mechanism 50B includes a first adjustable pulley unit 120, a second adjustable pulley unit 122 and a belt 124. The first adjustable pulley unit 120 is fixed for rotation with the rear output shaft 32 and is rotatably driven by the rear output shaft 32. The second adjustable pulley unit 122 is fixed for rotation with the front output shaft 42 and is driven by the first adjustable pulley unit 120 via the belt 124. As explained further below, the first adjustable pulley unit 120 is adjusted based on a setting of the second adjustable pulley unit 122 to vary the amount of torque transferred to the second adjustable pulley unit 122.

The first adjustable pulley unit 120 includes first and second pulley halves 126 and 128. The first pulley half 126 is fixed for rotation with the rear output shaft 32 and is fixed against axial movement along a linear axis A of the rear output shaft 32. The second pulley half 128 is fixed (i.e. splined) for rotation with the rear output shaft 32 and is slidable along the linear axis A. The second pulley half 128 is biased toward the first pulley half 126 by a spring 130. The second pulley half 128 moves along the axis A, against the biasing force of the spring 130 based on a setting of the second pulley 122. The spring rate of the spring 130 is selected to maintain a constant tension in the belt 124. More particularly, the tension in the belt 124 results in a linear force being imparted on the second pulley half 128. As the tension increases, the linear force increases and the second pulley half 128 compresses the spring 130 until an equilibrium is achieved. As the tension decreases, the linear force decreases and the second pulley half 128 is biased towards the first pulley half 126 by the spring 130 until an equilibrium is achieved. In this manner, the first operating radius (r₁) is automatically adjusted when the second operating radius (r₂) is adjusted to maintain a constant belt tension.

The second adjustable pulley unit 122 includes first and second pulley halves 132 and 134. The first pulley half 132 is rotatably and linearly fixed relative to the front output shaft 42. The second pulley half 134 is fixed (i.e. splined) for rotation with the first pulley half 132 and is axially slidable along the axis B. The actuator 52 is shown to include a ball-screw type operator 135 that includes first and second actuator sleeves 136,138 having first and second sets of ball grooves 140,142 respectively formed therein. Balls 144 ride within the first and second sets of ball grooves 140,142. The first actuator sleeve 136 is rotatably supported about the front output shaft 42. The second actuator sleeve 138 is concentrically aligned with and is disposed between the front output shaft 42 and the first actuator sleeve 136. The first actuator sleeve 136 abuts the second pulley half 134 and is slidable along the axis A to induce linear movement of the second pulley half 134.

The first actuator sleeve 136 is rotated by a drive mechanism 146 (e.g., electric motor, stepper motor) inducing linear movement of the first actuator sleeve 136 relative to the second actuator sleeve 138 and the second pulley half 134. When moving toward the second pulley half 134, the first actuator sleeve 136 imparts a linear force on the second pulley half 134. In this manner, the second pulley half 134 moves towards the first pulley half 132 and the operating radius (r₁) is increased. When moving away from the second pulley half 134, the first actuator sleeve 136 relieves the linear force on the second pulley half 134. In this manner, the second pulley half 134 moves away from the first pulley half 132 and the operating radius (r₂) is decreased. More specifically, the tension on the belt 124 pushes the second pulley half 134 away from the first pulley half 132 and the operating radius (r₂) is decreased.

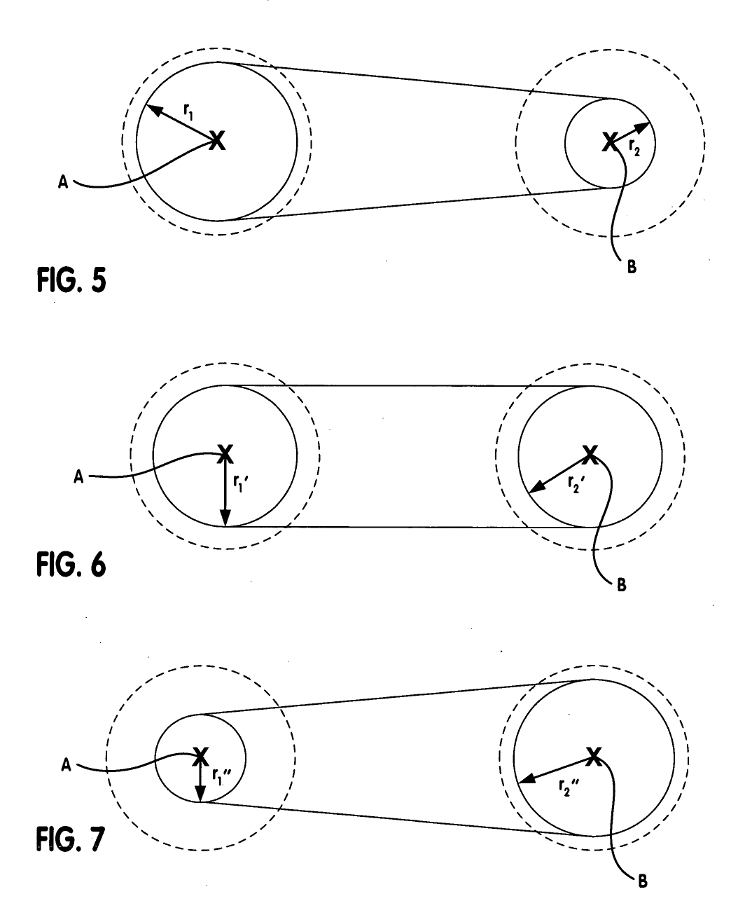

Referring now to FIGS. 5 through 7, the torque transfer mechanism of the present invention enables continuously variable torque transfer between the rear and front output shafts. The first pulley drives the traction belt at the first operating radius (r₁), which drives the second pulley at the second operating radius (r₂). As illustrated in FIG. 5, r₁ is greater than r₂. Therefore, the second pulley is driven at a higher speed and with less torque than the first pulley. As illustrated in FIG. 6, both r₁ and r₂ have been varied to r₁′ and r₂′, respectively. Because r₁′ and r₂′ are approximately equivalent, the second pulley is driven at the same speed and torque as the first pulley. This can be achieved in the case where both the first and second pulleys are adjustable. As illustrated in FIG. 7, both r₁ and r₂ have again been varied to r₁″ and r₂″, respectively. Because r₁″ is less than r₂″, the second pulley is driven at a lower speed and with higher torque than the first pulley. Again, this can be achieved in the case where both the first and second pulleys are adjustable.

A number of preferred embodiments have been disclosed to provide those skilled in the art an understanding of the best mode currently contemplated for the operation and construction of the present invention. The invention being thus described, it will be obvious that various modifications can be made without departing from the true spirit and scope of the invention, and all such modifications as would be considered by those skilled in the art are intended to be included within the scope of the following claims.

What is claimed is:

1. A power transfer system, comprising:
an input shaft that is rotatably driven by a power source;
a first output shaft that is coupled to said input shaft and that drives a first driveline;
a second output shaft that drives a second driveline; and
a torque transfer mechanism that selectively couples said first output shaft and said second output shaft, said torque transfer mechanism comprising:
a first pulley selectively coupled to said first output shaft;
a second pulley coupled to said second output shaft; and
a drive linkage that transfers drive torque between said first pulley and said second pulley, wherein a first operating radius of said first pulley is varied to vary torque transfer between said first output shaft and said second output shaft.

2. The power transfer system of claim 1 further comprising an actuator that adjusts said first operating radius.

3. The power transfer system of claim 2 wherein said actuator is a ball-ramp type actuator.

4. The power transfer system of claim 2 wherein said actuator is a ball-screw type actuator.

5. The power transfer system of claim 1 wherein said first pulley includes first and second pulley halves that are rotatably driven by said first output shaft, wherein said second pulley half is movable along a linear axis relative to said first pulley half to vary said first operating radius.

6. The power transfer system of claim 1 wherein a second operating radius of said second pulley is adjusted based on said first operating radius.

7. The power transfer system of claim 6 wherein said second operating radius is adjusted to maintain a tension in said drive linkage.

8. The power transfer system of claim 6 wherein said second pulley includes first and second pulley halves that rotatably drive said second output shaft, wherein said second pulley half is biased along a linear axis toward said first pulley half by a biasing member.

9. A transfer case that is driven by a power source and that transfers drive torque to first and second drivelines based on vehicle operating conditions, comprising:
an actuator that is controlled based on said vehicle operating conditions; and
a first output shaft that is driven by said power source and that drives said first driveline;
a second output shaft that drives said second driveline; and
a torque transfer mechanism that selectively couples said first output shaft and said second output shaft, said torque transfer mechanism comprising:
a first pulley selectively coupled to said first output shaft;
a second pulley coupled to said second output shaft; and
a drive linkage that transfers drive torque between said first pulley and said second pulley, wherein said actuator varies a first operating radius of said first pulley to regulate torque transfer between said first output shaft and said second output shaft.

10. The transfer case of claim 9 wherein said actuator is a ball-ramp type actuator.

11. The transfer case of claim 9 wherein said actuator is a ball-screw type actuator.

12. The transfer case of claim 9 wherein said first pulley includes first and second pulley halves that are rotatably driven by said first output shaft, wherein said second pulley half is movable along a linear axis relative to said first pulley half to vary said first operating radius.

13. The transfer case of claim wherein said actuator imparts a linear force on said second pulley half to regulate linear movement of said second pulley half.

14. The transfer case of claim 9 wherein a second operating radius of said second pulley is adjusted based on said first operating radius.

15. The transfer case of claim 14 wherein said second operating radius is adjusted to maintain a tension in said drive linkage.

16. The transfer case of claim 14 wherein said second pulley includes first and second pulley halves that rotatably drive said second output shaft, wherein said second pulley half is biased along a linear axis toward said first pulley half by a biasing member.
